(19) United States
(12) Patent Application Publication
(10) Pub. No.: US 2020/0319618 A1
(43) Pub. Date: Oct. 8, 2020

(54) EVALUATION WORK PIECE, NON-TRANSITORY COMPUTER READABLE MEDIUM RECORDING A MACHINING PROGRAM AND NON-TRANSITORY COMPUTER READABLE MEDIUM RECORDING A DATA STRUCTURE

(71) Applicant: FANUC CORPORATION, Yamanashi (JP)

(72) Inventors: Wei ZHAO, Yamanashi (JP); Nobuaki AIZAWA, Yamanashi (JP)

(21) Appl. No.: 16/808,823

(22) Filed: Mar. 4, 2020

(30) Foreign Application Priority Data
Apr. 3, 2019 (JP) 2019-071537

(51) Int. Cl. G05B 19/404; G05B 19/18; G05B 19/4097

(52) U.S. Cl. CPC G05B 19/404; G05B 2219/50297; G05B 19/4097; G05B 19/182

(57) ABSTRACT

An evaluation work piece which is machined with a multi-axis machine tool that includes three linear axes and one or more rotary axes includes: at least one of a curved surface portion in which the inclination of a tool is changed, a boundary portion of two regions of a flat surface which is machined at different angles of the tool and which includes the two adjacent regions and a corner portion in which the amount of movement of the rotary axis is larger than the amount of movement of a tool tip point. The curved surface portion is preferably formed to be a free curved surface. Preferably, the evaluation work piece includes: a stage-shaped machined portion; and a twisted machined portion which is formed on the stage-shaped machined portion, the boundary portion is formed in the front surface of the stage-shaped machined portion and the curved surface portion and the corner portion are formed in the twisted machined portion.

This application is based on and claims the benefit of priority from Japanese Patent Application No. 2019-071537, filed on 3 Apr. 2019, the content of which is incorporated herein by reference.

### BACKGROUND OF THE INVENTION

### Field of the Invention

The present invention relates to an evaluation work piece which is machined with a machine tool, a machining program and a data structure.

### Related Art

A method of evaluating, with an evaluation work piece, the displacement of a machine tool (three-axis machine tool) of an X axis, a Y axis and a Z axis is disclosed in, for example, patent document 1. Specifically, patent document 1 discloses a displacement evaluation method of a machine tool in which, for example, a displacement evaluation work piece having a grooved surface is installed in a machine tool having an X axis, a Y axis and a Z axis orthogonal to each other so as to achieve a state where the grooved surface is inclined with respect to the direction of the X axis and where a side of the grooved surface on one end side is parallel to the direction of the Y axis, in this state, a tool in the direction of the X axis without moving it in the direction of the Z axis so as to form a linear groove in the grooved surface is performed, in which this grooving is performed each time the tool is sequentially moved in the direction of the Y axis such that the linear grooves in individual rows are parallel to each other and in which thus a displacement in the direction of the Z axis is evaluated.

A numerical controller of a five-axis machine tool is disclosed in, for example, patent document 2. Specifically, patent document 2 discloses the numerical controller including: a direction compensation amount storage unit which stores a linear axis causing compensation amount that is associated with a combination of the position of the linear axis and the direction of movement of the linear axis and a rotary axis causing compensation amount that is associated with a combination of the position of a rotary axis and the direction of movement of the rotary axis; an axis movement direction determination unit which determines the direction of movement of each axis; a movement direction compensation amount acquisition unit which acquires, from the direction compensation amount storage unit, a linear axis causing compensation amount that is associated with the position of the linear axis and a command linear axis movement direction and a rotary axis causing compensation amount that is associated with the position of the rotary axis by a command and a command rotary axis movement direction; and a compensation unit which calculates a translational rotation compensation amount based on the linear axis causing compensation amount and the rotary axis causing compensation amount and which adds the translational rotation compensation amount to a command linear axis position.

Patent Document 1: Japanese Unexamined Patent Application, Publication No. 2012-86325

Patent Document 2: Japanese Unexamined Patent Application, Publication No. 2017-21554

### SUMMARY OF THE INVENTION

A machine tool (hereinafter referred to as a multi-axis machine tool) which includes three linear axes of an X axis, a Y axis and a Z axis and one or more rotary axes performs an operation of relatively and linearly moving a tool with respect to a table, and performs an operation of relatively inclining the tool with respect to the table. The multi-axis machine tool is, for example, a four-axis machine tool or a five-axis machine tool. The multi-axis machine tool is affected by various factors such as a machining program, a numerical controller and a machine, and thus it is desired to provide an evaluation work piece, a machining program and a data structure for evaluating influences of these factors exerted on machining.

(1) An aspect of the present disclosure is an evaluation work piece which is machined with a multi-axis machine tool that includes three linear axes and one or more rotary axes, and which includes: at least one of a curved surface portion in which the inclination of a tool is changed, a boundary portion of two regions of a flat surface which is machined at different angles of the tool and which includes the two adjacent regions and a corner portion in which the amount of movement of the rotary axis is larger than the amount of movement of a tool tip point.

(2) Another aspect of the present disclosure is a machining program for instructing a computer serving as a numerical controller which drives a multi-axis machine tool that includes three linear axes and one or more rotary axes so as to produce an evaluation work piece to execute at least one of processing in which the inclination of a tool is changed so as to form a free curved surface, processing in which in a boundary portion of two adjacent regions of a flat surface, machining is performed at different angles of the tool between the two regions and processing in which the amount of movement of the rotary axis of the tool is set larger than the amount of movement of a tool tip point so as to form a corner portion.

(3) Yet another aspect of the present disclosure is a data structure of CAD data in a control system which includes: a CAM device that generates a machining program based on the CAD data; and a numerical controller that drives, based on the machining program, a multi-axis machine tool including three linear axes and one or more rotary axes so as to produce an evaluation work piece, and the data structure is provided for machining at least one of, in the evaluation work piece, a curved surface portion in which the inclination of a tool is changed and which is formed with a free curved surface, a boundary portion of two regions of a flat surface which is machined at different angles of the tool and which includes the two adjacent regions and a corner portion in which the amount of movement of the rotary axis of the tool is larger than the amount of movement of a tool tip point.

According to the aspects of the present disclosure, it is possible to evaluate influences of various factors such as a machining program, a numerical controller and a machine exerted on machining performed with a machine tool.

### BRIEF DESCRIPTION OF THE DRAWINGS

FIG. 1 is a block diagram showing the configuration of a control system of a machine tool which produces an evaluation work piece;

FIG. 2 is a perspective view showing a five-axis machine tool of a table rotation type;

FIG. 3 is a perspective view showing a five-axis machine tool of a mixed type;

FIG. 4 is a perspective view showing a five-axis machine tool of a head rotation type;

FIG. 5A is a perspective view showing the movement of the five-axis machine tool of the head rotation type;

FIG. 5B is a perspective view showing the movement of the five-axis machine tool of the head rotation type;

FIG. 5C is a perspective view showing the movement of the five-axis machine tool of the head rotation type;

FIG. 6 is a plan view of an evaluation work piece according to an embodiment of the present disclosure;

FIG. 7 is a front view of the evaluation work piece according to the embodiment of the present disclosure;

FIG. 8 is a back view of the evaluation work piece according to the embodiment of the present disclosure;

FIG. 9 is a left side view of the evaluation work piece according to the embodiment of the present disclosure;

FIG. 10 is a right side view of the evaluation work piece according to the embodiment of the present disclosure;

FIG. 11 is a perspective view of the evaluation work piece shown in FIG. 6 in a leftwardly-diagonal upward direction;

FIG. 12 is a perspective view of the evaluation work piece shown in FIG. 6 in a rightwardly-diagonal downward direction;

FIG. 13 is an illustrative view for illustrating an operation of machining the work piece with a tool in three-axis machining;

FIG. 14 is an illustrative view for illustrating an operation of machining the work piece with the tool in five-axis machining;

FIG. 15 is an illustrative view for illustrating an operation of machining the work piece with the tool in the five-axis machining when a machining program in which the inclination of the tool is not smooth is used;

FIG. 16 is an illustrative view showing a crease that occurs when the machining program in which the inclination of the tool is not smooth is used;

FIG. 17 is an illustrative view showing how a uniform flat surface which is a target is formed with the tool when a five-axis machine tool uses the tool to machine the flat surface at two angles;

FIG. 18 is an illustrative view showing how a surface having a step is formed with the tool when the physical rotary axis center of the machine does not coincide with a rotary axis center set in a parameter of a numerical controller;

FIG. 19A is a diagram showing a state where the tool is vertically arranged with respect to the flat surface when the two rotary axis centers coincide with each other;

FIG. 19B is a diagram showing a state where the tool is rotated by 60 degrees with the rotary axis center set to a center point when the two rotary axis centers coincide with each other;

FIG. 19C is a diagram showing a state where the tool is moved only by a predetermined amount of movement such that a tool tip is arranged on the upper surface of the work piece when the two rotary axis centers coincide with each other;

FIG. 20A is a diagram showing a state where the tool is vertically arranged with respect to the flat surface when the two rotary axis centers are displaced from each other;

FIG. 20B is a diagram showing a state where the tool is rotated by 60 degrees with the rotary axis center set to the center point when the two rotary axis centers are displaced from each other;

FIG. 20C is a diagram showing a state where the tool is moved only by the predetermined amount of movement such that the tool tip is arranged on the upper surface of the work piece when the two rotary axis centers are displaced from each other;

FIG. 21 is an illustrative view showing how machining is performed at different angles of the tool in adjacent regions of the flat surface;

FIG. 22 is an illustrative view showing how the inclination of the tool is changed by 90 degrees at a corner when a work piece in the shape of a rectangular parallelepiped is machined; and

FIG. 23 is an illustrative view showing how the posture of the tool is rapidly changed at a corner of a boundary between two side surfaces of a twisted machined portion.

### DETAILED DESCRIPTION OF THE INVENTION

Embodiments of the present disclosure will be described in detail below with reference to drawings.

### First Embodiment

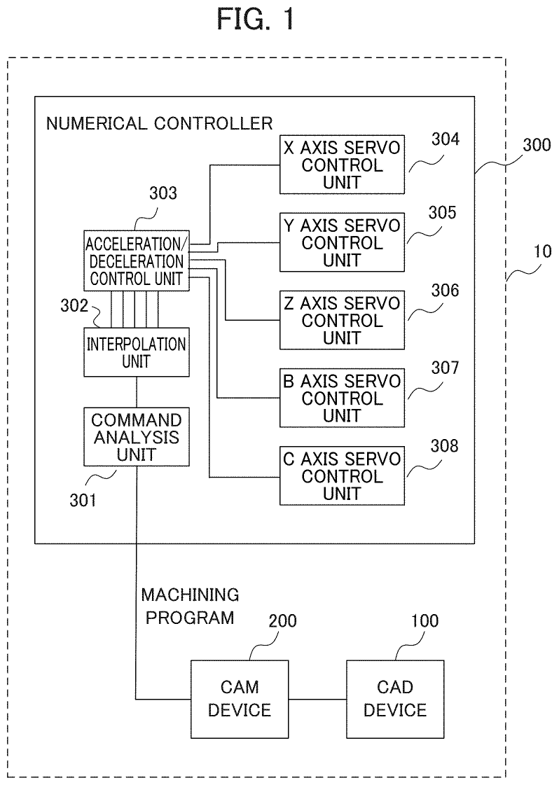

A control system of a machine tool which produces an evaluation work piece according to the present disclosure will first be described. FIG. 1 is a block diagram showing the configuration of the control system of the machine tool which produces the evaluation work piece. As shown in FIG. 1, the control system 10 of the machine tool which produces the evaluation work piece includes a CAD (Computer Aided Design) device 100, a CAM (Computer Aided Manufacturing) device 200 and a numerical controller 300 such as a CNC (Computerized Numerical Control) device.

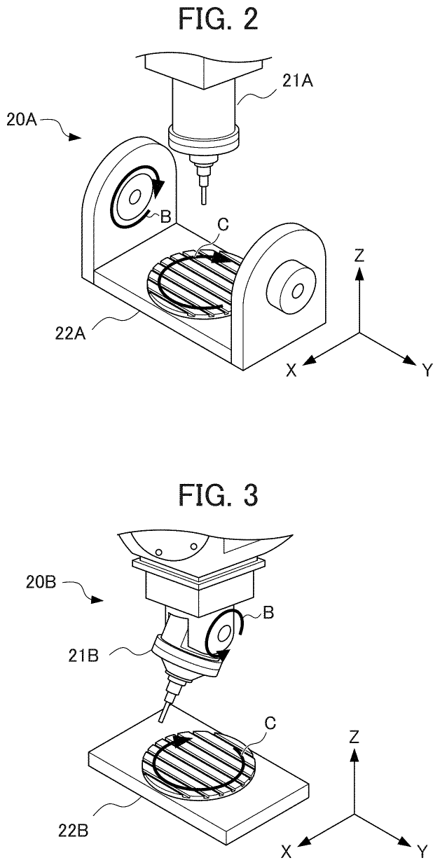

The machine tool controlled by the numerical controller 300 is a multi-axis machine tool. As already described, the multi-axis machine tool is a machine tool which includes three linear axes of an X axis, a Y axis and a Z axis and one or more rotary axes and examples of which include a four-axis machine tool, a five-axis machine tool and the like. In the following discussion, examples using five-axis machine tools will be described. FIGS. 2 to 4 are perspective views showing examples of the configuration of the five-axis machine tool which includes the three linear axes of the X axis, the Y axis and the Z axis and two rotary axes of a B axis and a C axis.

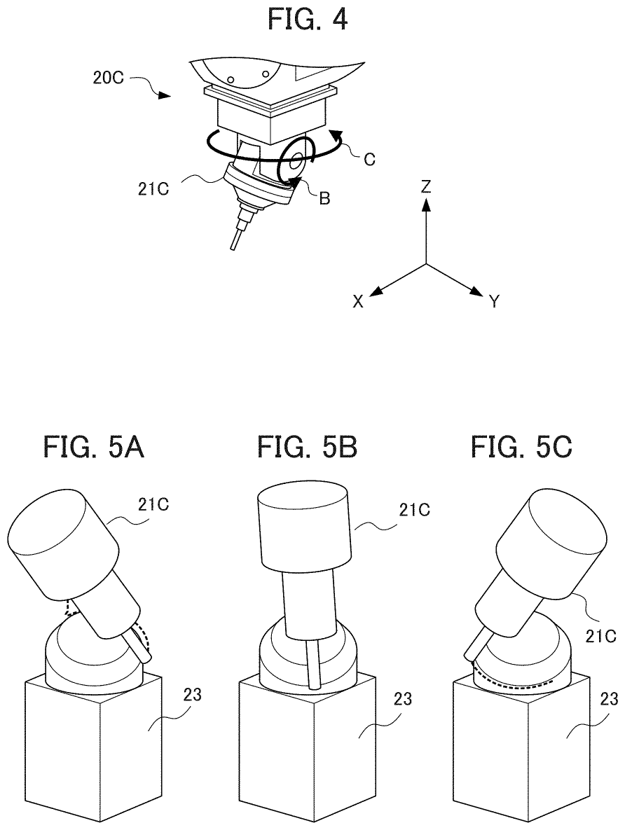

FIG. 2 is a perspective view showing the five-axis machine tool of a table rotation type. FIG. 3 is a perspective view showing the five-axis machine tool of a mixed type. FIG. 4 is a perspective view showing the five-axis machine tool of a head rotation type. FIGS. 5A, 5B and 5C each are perspective views showing a movement of the five-axis machine tool of the head rotation type. The configuration of the evaluation work piece produced with the five-axis machine tool will be described later.

The five-axis machine tool 20A of the table rotation type shown in FIG. 2 linearly moves a table 22A in the directions of the X axis, the Y axis and the Z axis, and rotationally moves the table 22A in the directions of the B axis and the C axis. The position of a head 21A is fixed. The five-axis machine tool 20B of the mixed type shown in FIG. 3 linearly moves a table 22B in the directions of the X axis, the Y axis and the Z axis and rotationally moves the table 22B in the direction of the C axis, and rotationally moves a head 21B in the direction of the B axis. In the five-axis machine tool 20C of the head rotation type shown in FIG. 4, the position of a table (not shown) is fixed, and a head 21C is linearly moved in the directions of the X axis, the Y axis and the Z axis and is rotationally moved in the directions of the B axis and the C axis. In the five-axis machine tool of the head rotation type, as shown in FIGS. 5A, 5B and 5C, the head 21C is directed in various directions so as to machine a work piece 23. As a tool attached to the heads 21A, 21B and 21C, for example, a ball end mill can be used.

Although in the present embodiment, an example where the five-axis machine tool 20C of the head rotation type is used will be described, there is no particular limitation to the five-axis machine tool of the head rotation type, the five-axis machine tool of the table rotation type or the five-axis machine tool of the mixed type may be used and the following description can also be applied to the five-axis machine tool of the table rotation type or the five-axis machine tool of the mixed type.

The CAD device 100 uses a CPU so as to execute CAD software for performing drawing on the screen of a computer. The drawing of the evaluation work piece is performed with a two-dimensional CAD or a three-dimensional CAD. When the two-dimensional CAD is used, on the plane of X and Y, a front view, a top view, a side view and the like of the evaluation work piece are produced. When the three-dimensional CAD is used, on a three-dimensional space of X, Y and Z, a three-dimensional image of the evaluation work piece is formed. The structure of CAD data will be described later.

The CAM device 200 executes, on the computer, with the CPU, CAM software for generating a machining program based on the shape of the evaluation work piece produced with the CAD device 100. The machining program is a program for producing the evaluation work piece by multi-axis machining such as five-axis machining, and includes information of the X axis, the Y axis and the Z axis, information on a rotary axis command point such as the inclination of the tool, the type of tool, information on the dimensions of the tool and the like, a feed rate and information on a spindle speed and the like.

The numerical controller 300 includes a command analysis unit 301, an interpolation unit 302 and an acceleration/deceleration control unit 303. The command analysis unit 301 sequentially reads, from the machining program generated by the CAM device 200, a block including commands for movements of the X axis, the Y axis, the Z axis, the B axis and the C axis so as to analyze the block, calculates movement command data for commanding the movements of the individual axes based on the result of the analysis and outputs the calculated movement command data to the interpolation unit 302. As described above, in the machining program of five-axis machining, in addition to the information of the X axis, the Y axis and the Z axis, information on the inclination of the tool is included in a rotary axis command point, and these pieces of information are used so as to calculate the movement command data for commanding the movements of the individual axes.

Based on a movement command which is commanded by the movement command data output from the command analysis unit 301, the interpolation unit 302 generates interpolated data obtained by calculating points on a command path by interpolation in an interpolation cycle. Based on the interpolated data output from the interpolation unit 302, the acceleration/deceleration control unit 303 performs acceleration/deceleration processing so as to calculate the speeds of the individual axes in each interpolation cycle, and outputs data based on the result of the calculation to an X axis servo control unit 304, a Y axis servo control unit 305, a Z axis servo control unit 306, a B axis servo control unit 307 and a C axis servo control unit 308.

The X axis servo control unit 304, the Y axis servo control unit 305 and the Z axis servo control unit 306 respectively control three servo motors (not shown) which drive the three linear axes of the X axis, the Y axis and the Z axis, and the B axis servo control unit 307 and the C axis servo control unit 308 respectively control two servo motors (not shown) which drive the two rotary axes of the B axis and the C axis.

The servo motors of the individual axes of the X axis, the Y axis, the Z axis, the B axis and the C axis include detectors for detecting positions and velocities, feed back position feedback signals and velocity feedback signals from the detectors to the X axis servo control unit 304, the Y axis servo control unit 305, the Z axis servo control unit 306, the B axis servo control unit 307 and the C axis servo control unit 308 and thereby perform feedback control on the positions and velocities. The servo control units 304 to 308 of the individual axes include a position control unit and a velocity control unit for configuring a position feedback loop and a velocity feedback loop, a motor drive amplifier for driving a feed axis motor based on a torque command value and the like.

Since the position feedback loop and the velocity feedback loop are well known by a person skilled in the art, the detailed description and illustration thereof will be omitted.

Although the numerical controller 300 includes a spindle control unit which receives a spindle rotation command and which rotates and controls a spindle motor so as to drive the tool, the spindle control unit is not related to the movement control of the tool, and thus the description thereof will be omitted.

In the control system 10 of the machine tool described above, the CAD device 100 and the CAM device 200 may be integrally formed with one computer. The CAD device 100 and the CAM device 200 may be included in the numerical controller 300.

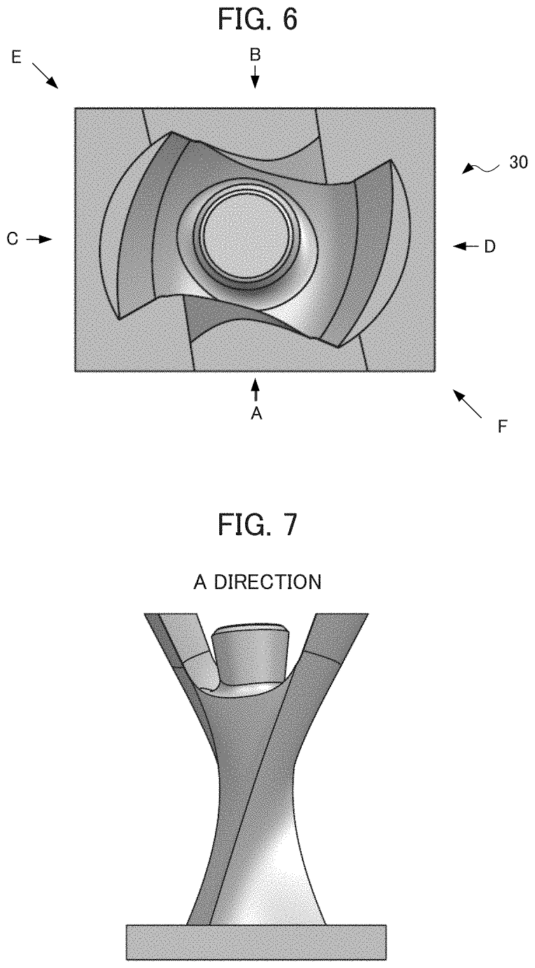

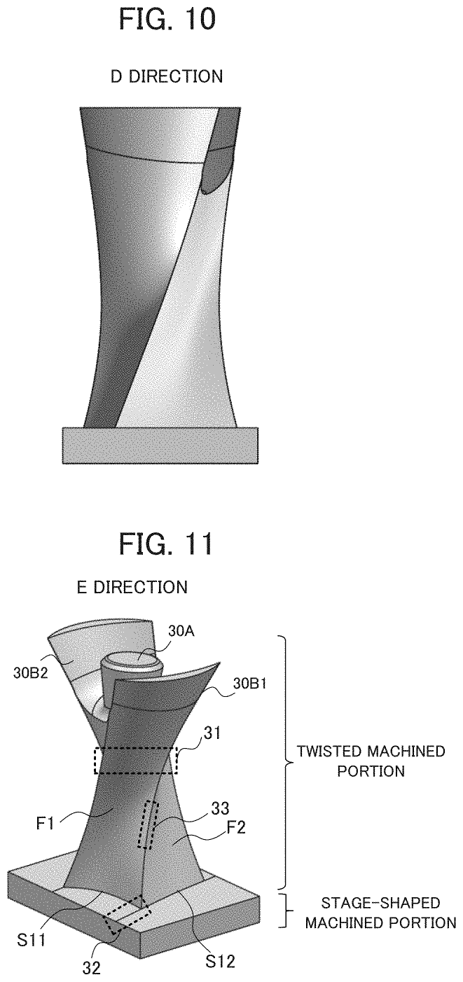

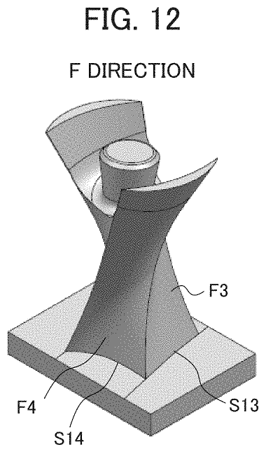

The evaluation work piece according to the embodiment of the present disclosure which is machined with the control system 10 of the machine tool will then be described. The evaluation work piece of the present disclosure includes three evaluation portions so as to be able to measure three evaluation items. FIG. 6 is a plan view (top view) of the evaluation work piece according to the embodiment of the present disclosure. FIGS. 7 to 10 are a front view, a back view, a left side view and a right side view of the evaluation work piece according to the embodiment of the present disclosure, and are diagrams when seen in the A direction, the B direction, the C direction and the D direction of the evaluation work piece shown in FIG. 6. FIGS. 11 and 12 are a perspective view of the evaluation work piece shown in FIG. 6 in a leftwardly-diagonal upward direction and a perspective view thereof in a rightwardly-diagonal downward direction, and are diagrams when seen in the E direction and the F direction of the evaluation work piece shown in FIG. 6.

The evaluation work piece 30 of the present embodiment includes a stage-shaped machined portion and a twisted machined portion, and a part in which the twisted machined portion and the stage-shaped machined portion make contact with each other is, as shown in FIGS. 11 and 12, a quadrangle that is formed with two opposite arc-shaped sides S11 and S14 and two opposite linear sides S12 and S13. Four side surfaces F1 to F4 which are extended from the four sides S11 to S14 are twisted upward from the stage-shaped machined portion so as to form free curved surfaces in which the front surfaces of the side surfaces F1 to F4 are changed in shape. The free curved surface is a curved surface which cannot be expressed with a simple mathematical formula unlike a sphere, a cylinder and the like, and refers to a curved surface in which some intersections and curvatures are set in a space and in which the intersections each are interpolated with a higher order equation.

As is clear from FIGS. 11 and 12, an upper portion of the twisted machined portion includes a cylindrical center portion 30A and two side portions 30B1 and 30B2. The two side portions 30B1 and 30B2 are formed around the cylindrical center portion 30A. As shown in FIG. 11, the evaluation work piece 30 includes: a curved surface portion 31 in which the inclination of the tool is changed; a boundary portion 32 of two regions of a flat surface which is machined at different angles of the tool and which includes the two adjacent regions; and a corner portion 33 in which the amount of movement of the rotary axis is larger than the amount of movement of a tool tip point. The curved surface portion 31, the boundary portion 32 and the corner portion 33 are the three evaluation portions which are included in the evaluation work piece of the present disclosure. The individual evaluation portions will be described below.

<Curved surface portion 31>

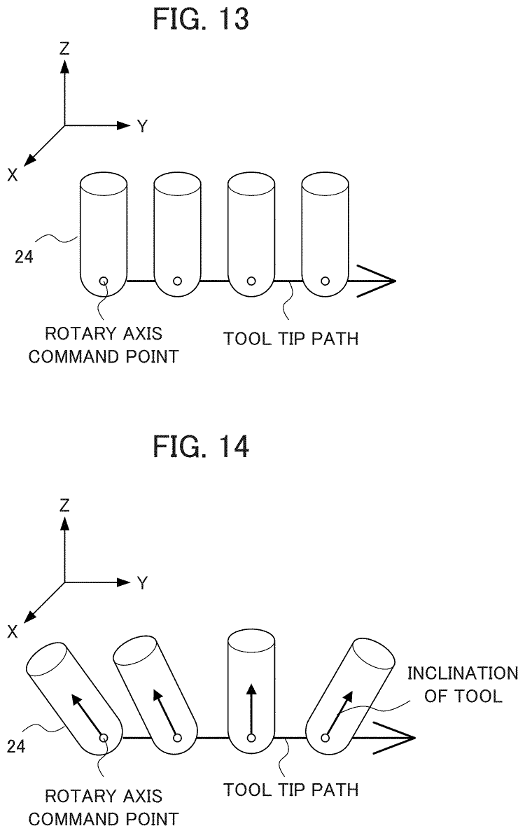

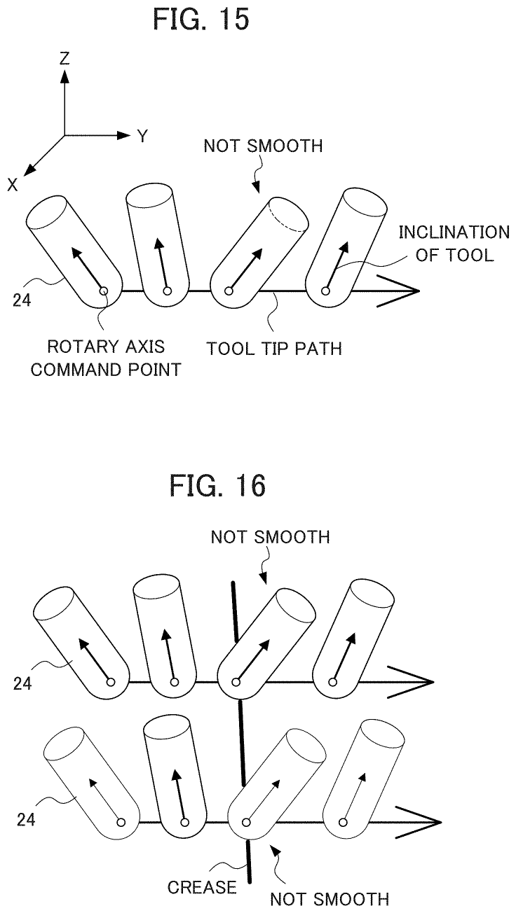

As shown in FIG. 13, in three-axis machining, only the information of the X axis, the Y axis and the Z axis of the tool 24 is described in the rotary axis command point of the machining program, the numerical controller 300 sets a tool tip path based on the rotary axis command point and the tool 24 vertically machines the work piece (machined article) along the tool tip path. On the other hand, as shown in FIG. 14, in five-axis machining, in addition to the information of the X axis, the Y axis and the Z axis, information on the inclination of the tool 24 is included in the rotary axis command point of the machining program, and even when the tool tip path is the same, machining can be performed while the inclination of the tool 24 is being changed. In FIG. 14, the inclinations of the tool 24 are indicated by arrows. Although when in the five-axis machining, the machining is performed while the inclination is being changed, the machining program in which the inclination of the tool is smoothly changed is preferable, when the setting of the CAM device 200 is not appropriate, the machining program in which the inclination of the tool is not smooth as shown in FIG. 15 can be generated.

A part in which the movement of the rotary axis is not smooth is referred to as a “disturbance in the rotary axis command point”, and in particular, a disturbance easily occurs in a free curved surface. When a disturbance in the rotary axis command point occurs, in actual machining, the movement of the tool is not smooth in the part in which the disturbance in the rotary axis command point occurs, with the result that how the tool and the work piece make contact with each other (the state of the contact part) differs such that a crease as shown in FIG. 16 is formed. This problem easily occurs particularly when machining is performed with the side surface of the tool.

As shown in FIG. 11, the curved surface portion 31 of the evaluation work piece 30 in the present embodiment is formed in a part of the side surface F1 extended from the stage-shaped machined portion, the side surface is twisted upward from the stage-shaped machined portion and thus a free curved surface in which the front surface of the side surface F1 is changed in shape is formed. In the curved surface portion 31, machining is performed while the inclination of the tool is being changed, and thus a disturbance in the rotary axis command point easily occurs, with the result that a crease occurs. Whether or not a crease occurs in the curved surface portion 31 included in the evaluation work piece 30 is observed, and thus it is possible to evaluate whether or not the inclination of the tool included in the rotary axis command point of the machining program is appropriate.

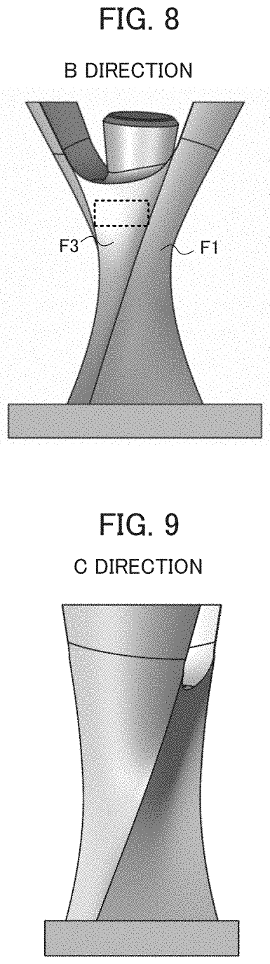

Although in the evaluation work piece 30, the curved surface portion 31 of the side surface F1 shown in FIG. 11 is set to the evaluation portion, a curved surface portion of any one of the side surfaces F2 to F4 shown in FIGS. 11 and 12 may be set to the evaluation portion, and, for example, a curved surface portion indicated by a dotted region of the side surface F3 shown in FIG. 8 may be set to the evaluation portion. The curved surface portions of a plurality of side surfaces among the side surfaces F2 to F4 may be set to the evaluation portions.

### <Boundary Portion 32>

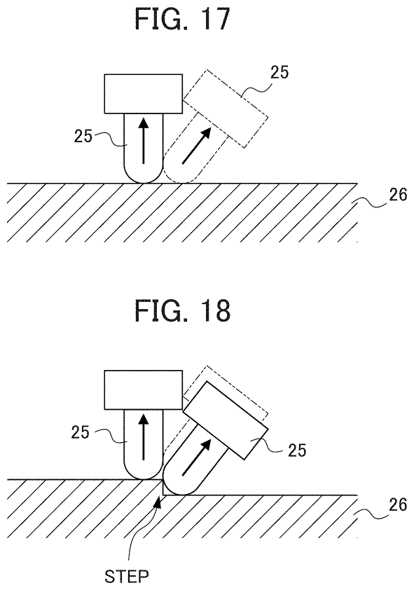

When the five-axis machine tool uses the tool so as to machine a flat surface at two angles, as a target, as shown in FIG. 17, a uniform flat surface is preferably formed in a work piece 26, and in the actual machining, however, as shown in FIG. 18, when a displacement in the rotary axis center position of the tool is caused, a step is formed in the front surface of the work piece 26. In FIGS. 17 and 18, a tool portion 25 indicated by dotted lines indicates a tool portion which is moved from a tool portion 25 indicated by solid lines to a target position. For example, in the head 21C of FIG. 4, the tool portion 25 indicates the tool and a support portion which rotatably supports the tool in the direction of the B axis. A displacement in the rotary axis center position is caused by the fact that the physical rotary axis center of the machine does not coincide with a rotary axis center which is set in a parameter of the numerical controller 300. This displacement occurs so as to adversely affect the entire five-axis machine tool, and thus for example, as shown in FIG. 18, the step is formed in the flat surface.

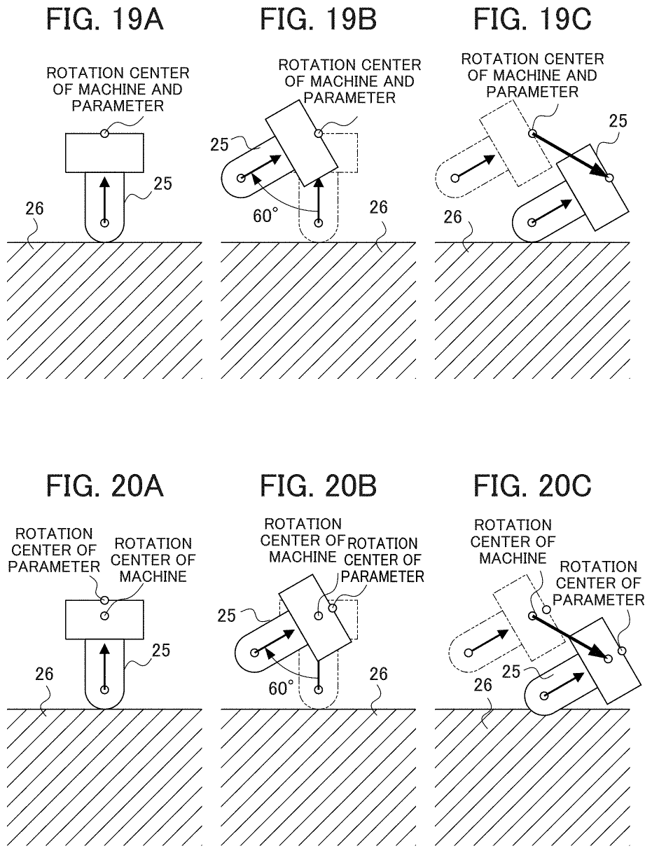

The reason why the step is formed when a displacement in the rotary axis center position is caused will be described below. For simplification, a case where a command for moving a tool tip to the upper surface of the work piece is provided in a state in which the tool is rotated by 60 degrees will be described as an example. FIGS. 19A, 19B and 19C are respectively a diagram showing a state where the tool is vertically arranged with respect to the flat surface, a diagram showing a state where the tool is rotated by 60 degrees with the rotary axis center set to a center point and a diagram showing a state where the tool is moved only by a predetermined amount of movement from the state shown in FIG. 19B such that the tool tip is arranged on the upper surface of the work piece when the physical rotary axis center of the machine coincides with the rotary axis center set in the parameter of the numerical controller 300. FIGS. 20A, 20B and 20C are respectively a diagram showing a state where the tool is vertically arranged with respect to the flat surface, a diagram showing a state where the tool is rotated by 60 degrees with the rotary axis center set to the center point and a diagram showing a state where the tool is moved only by the predetermined amount of movement from the state shown in FIG. 20B such that the tool tip is arranged on the upper surface of the work piece when the physical rotary axis center of the machine is displaced from the rotary axis center (which corresponds to the rotary axis center shown in FIGS. 19A to 19C) set in the parameter of the numerical controller.

The physical rotary axis center of the machine is a center about which the tool is rotated, and is, for example, a center about which the tool is rotated in the direction of the B axis in the head 21C of FIG. 4. When the physical rotary axis center of the machine coincides with the rotary axis center set in the parameter of the numerical controller 300, as shown in FIG. 19C, the predetermined amount of movement calculated with the numerical controller 300, specifically, the amount of movement (which is indicated by a thick arrow of FIG. 19C) for moving the tool tip in a state where the tool is rotated by 60 degrees to the upper surface of the work piece is appropriately set, with the result that the tool tip is moved from the arrangement of the tool in FIG. 19B to a position on the flat surface serving as the target. However, when the physical rotary axis center of the machine is displaced from the rotary axis center set in the parameter of the numerical controller 300, as shown in FIG. 20C, in the actual movement of the machine, the tool tip is moved to a position displaced downward from the position on the flat surface serving as the target when the tool is moved only by the same predetermined amount of movement (which is indicated by a thick arrow of FIG. 20C) as in FIG. 19C, with the result that the step is formed in the flat surface when the work piece is machined with the tool.

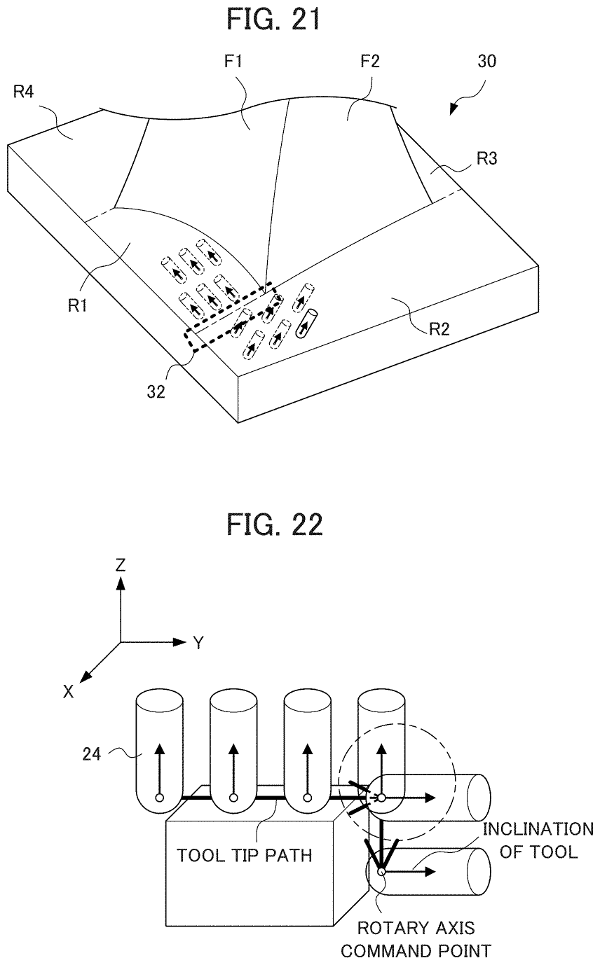

In the evaluation work piece 30 of the present embodiment, as shown in FIG. 21, the flat surface of the stage-shaped machined portion is divided into four regions R1 to R4, and machining is performed such that the tool is inclined at different angles between adjacent regions. For example, as shown in FIG. 21, the machining is performed with the tool at different angles between the region R1 and the region R2. The state of the step formed in the boundary portion 32 of the adjacent regions R1 and R2 of the evaluation work piece 30 is observed, and thus it is possible to evaluate a displacement in the rotary axis center position of the machine.

Although in the evaluation work piece 30, the boundary portion 32 between the regions R1 and R2 shown in FIG. 21 is set to the evaluation portion, the machining may be performed at different angles of the tool between two adjacent regions among the regions R1 to R4 shown in FIG. 21, and a boundary portion between the regions (other than the boundary portion 32) may be set to the evaluation portion. In the regions R1 to R4, a plurality of adjacent regions in which the machining is performed at different angles of the tool may be provided, and boundary portions between the regions may be set to the evaluation portions.

### <Corner Portion 33>

There is a case where the posture of the tool needs to be rapidly changed depending on the shape. For example, when as shown in FIG. 22, a work piece 27 in the shape of a rectangular parallelepiped is machined, the inclination of the tool 24 is significantly changed by 90 degrees at a corner, and thus a crease may occur in a machined surface due to the influence of acceleration/deceleration. When the tool 24 approaches the corner, the speed of the feed axis of the tool 24 is changed from low speed to deceleration, the tool 24 is stopped at the corner, the posture of the tool 24 is rotated by 90 degrees and after the rotation, the speed of the feed axis of the tool 24 is changed from stop to acceleration. Even in the rotation of the tool 24, when the tool 24 reaches the corner, the posture of the tool which is fixed is changed by 90 degrees by the rotation of the tool 24, and thereafter the posture of the tool 24 is fixed. In the movement of the tool as described above, vibrations occur in the machine, and thus a crease occurs in the machined surface.

The occurrence of vibrations in the machine is dynamically considered as follows. A rapid speed change in the motor serves as a disturbance, the disturbance is transmitted through a ball screw to the tool coupled to the tip of the ball screw and thus the tool is displaced from an equilibrium position. The tool which is displaced from the equilibrium position by the disturbance attempts to return to its original position. In this way, the tool is vibrated by the disturbance. Vibrations also occur in the motor and the tool by the rapid rotation start and rotation stop of the motor which rotates the tool at the corner. Although as shown in FIG. 4, the five-axis machine tool of the head rotation type is used so as to cause vibrations in the tool or the motor, when as shown in FIG. 2, the table 22A is linearly moved and is rotationally moved, vibrations occur in the table whereas when as shown in FIG. 3, the table 22B is rotationally moved, vibrations occur in the table and in the tool. In the part of the corner as described above, it is important to smoothly perform control on the posture of the tool and control on the acceleration/deceleration with the numerical controller 300.

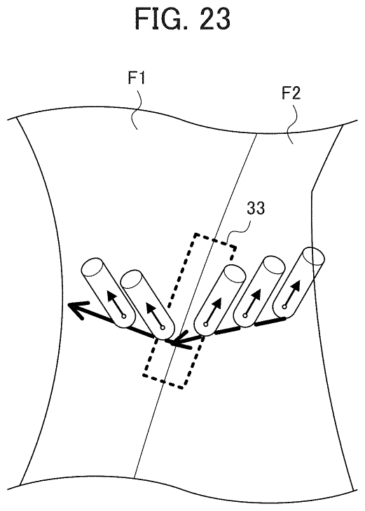

In the evaluation work piece 30 of the present embodiment, as shown in FIG. 23, in the boundary between the side surface F1 and the side surface F2 of the twisted machined portion, the sharp corner portion 33 in which the posture of the tool is rapidly changed is provided, with the result that in the corner portion, the amount of movement of the rotary axis of the tool is larger than the amount of movement of the tool tip point. Whether or not a crease occurs in the machined surface in front of and behind the edge of the corner portion 33 is observed, and thus the acceleration/deceleration control of the numerical controller is evaluated. Although in the evaluation work piece 30, as shown in FIG. 23, the corner portion 33 between the side surface F1 and the side surface F2 is set to the evaluation portion, a corner portion (other than the corner portion 33) between two adjacent side surfaces among the side surfaces F1 to F4 shown in FIGS. 11 and 12 may be set to the evaluation portion. In the side surfaces F1 to F4, a plurality of corner portions in adjacent side surfaces may be set to the evaluation portions.

Although in the embodiment described above, the three evaluation portions are formed in one evaluation work piece, any one of the three evaluation portions may be formed in one evaluation work piece or two of the three evaluation portions may be combined so as to be formed in one evaluation work piece.

The evaluation work piece is not limited to the example where the stage-shaped machined portion and the twisted machined portion are provided, and as long as the curved surface portion 31, the boundary portion 32 and the corner portion 33 can be formed, another shape may be adopted. For example, although a disturbance in the rotary axis command point easily occurs in a free curved surface, and thus the curved surface portion 31 is provided in the twisted side surface, if a disturbance in the rotary axis command point occurs, a pillar-shaped member or the like which includes a concave curved surface or a convex curved surface may be provided. The evaluation work piece 30 has a shape suitable for a case where the corner portion 33 is provided together with the curved surface portion 31, and when only the corner portion is provided or the corner portion and the boundary portion 32 are provided, the rectangular parallelepiped as shown in FIG. 22 may be provided on the stage-shaped machined portion instead of the twisted machined portion.

The machining program and a CAD data structure which are used in the control system of the machine tool for producing the already described evaluation work piece will then be described. An embodiment of the machining program of the present disclosure is generated by the CAM device 200 with the CAM software based on the shape of the evaluation work piece produced with the CAD device 100 and shown in FIGS. 6 to 12.

### <Machining Program>

The machining program is a machining program which executes at least one of processing in which the inclination of the tool is changed so as to form a free curved surface, processing in which in the boundary portion of two adjacent regions in the flat surface, machining is performed at different angles of the tool between the two regions and processing in which the amount of movement of the rotary axis of the tool is set larger than the amount of movement of the tool tip point so as to form a corner portion. The processing in which the inclination of the tool is changed so as to form a free curved surface is, for example, the processing in which the numerical controller 300 is used to generate the curved surface portion 31 of the side surface F1 shown in FIG. 11. The processing in which in the boundary portion of two adjacent regions in the flat surface, machining is performed at different angles of the tool between the two regions is, for example, the processing in which the numerical controller 300 is used to perform machining at different angles of the tool between the region R1 and the region R2 of the front surface of the stage-shaped machined portion shown in FIG. 21.

The processing in which the amount of movement of the rotary axis of the tool is set larger than the amount of movement of the tool tip point so as to form a corner portion is, for example, the processing in which the numerical controller 300 is used and in which thus when as shown in FIG. 23, the tool is moved from the side surface F2 to the side surface F1 through the corner portion 33, as illustrated in FIG. 22, the amount of movement of the rotary axis of the tool is set larger than the amount of movement of the tool tip point so as to form the corner portion.

The machining program can be stored with various types of non-transitory computer readable media and supplied to a computer. The non-transitory computer readable media include various types of tangible storage media. Examples of the non-transitory computer readable medium include a magnetic recording medium (for example, a hard disk drive), a magneto-optical recording medium (for example, a magneto-optical disk), a CD-ROM (Read Only Memory), a CD-R, a CD-R/W and semiconductor memories (for example, a mask ROM, a PROM (Programmable ROM), an EPROM (Erasable PROM), a flash ROM and a RAM (random access memory)).

### <CAD Data Structure>

The CAD data structure is a data structure of CAD data in the control system of a multi-axis machine tool which generates a machining program based on the CAD data with a CAM device and which drives the multi-axis machine tool so as to produce an evaluation work piece. The CAD data structure is the data structure for machining at least one of a curved surface portion in which the inclination of a tool is changed and which is formed with a free curved surface, a boundary portion of two regions of a flat surface which is machined at different angles of the tool and which includes the two adjacent regions and a corner portion in which the amount of movement of a rotary axis is larger than the amount of movement of a tool tip point.

The data structure for machining a curved surface portion in which the inclination of a tool is changed and which is formed with a free curved surface is, for example, the data structure which produces the curved surface portion 31 shown in FIG. 11 and which indicates the curved surface portion 31 that is twisted upward from the stage-shaped machined portion and that is formed in a part of the side surface F1 forming the free curved surface where the shape of the front surface is changed.

The data structure for machining a boundary portion of two regions of a flat surface which is machined at different angles of the tool and which includes the two adjacent regions is, for example, the data structure which indicates the boundary portion 32 that is machined with the tool at different angles between the region R1 and the region R2 as shown in FIG. 21.

The data structure for machining at least one of a corner portion in which the amount of movement of a rotary axis is larger than the amount of movement of a tool tip point is, for example, the data structure which produces the corner portion 33 shown in FIG. 11 and which indicates the sharp corner portion 33 where the posture of the tool is rapidly changed in the boundary between the side surface F1 and the side surface F2 in the corner portion 33.

Although the embodiment described above is a preferred embodiment of the present invention, the scope of the present invention is not limited to only the embodiment described above, and various modifications can be practiced without departing from the spirit of the present invention.

In the machine learning device, the control system and the machine learning method of the present disclosure, various types of embodiments, including the embodiment described above, which have configurations as described below can be provided.

(1) An aspect of the present disclosure is an evaluation work piece (for example, the evaluation work piece 30) which is machined with a multi-axis machine tool (for example, the five-axis machine tool 20A, 20B or 20C) that includes three linear axes and one or more rotary axes, and which includes: at least one of a curved surface portion (for example, the curved surface portion 31) in which the inclination of a tool is changed, a boundary portion (for example, the boundary portion 32) of two regions of a flat surface which is machined at different angles of the tool and which includes the two adjacent regions and a corner portion (for example, the corner portion 33) in which the amount of movement of the rotary axis is larger than the amount of movement of a tool tip point.

(2) Preferably, in the evaluation work piece according to (1) described above, the curved surface portion is formed to be a free curved surface.

(3) Preferably, in the evaluation work piece according to (1) or (2) described above, the evaluation work piece includes: a stage-shaped machined portion; and a twisted machined portion which is formed on the stage-shaped machined portion, the boundary portion is formed in a front surface of the stage-shaped machined portion and the curved surface portion and the corner portion are formed in the twisted machined portion.

(4) Preferably, in the evaluation work piece according to any one of (1) to (3) described above, the multi-axis machine tool is a machine tool (for example, the five-axis machine tool 20A, 20B or 20C) of a table rotation type in which a table is linearly moved and is rotationally moved, a machine tool (for example, the five-axis machine tool 20B) of a mixed type in which a table is linearly moved and in which a head is rotationally moved or a machine tool (for example, the five-axis machine tool 20C) of a head rotation type in which a head is linearly moved and is rotationally moved.

(5) Another aspect of the present disclosure is a machining program for instructing a computer serving as a numerical controller (for example, the numerical controller 300) which drives a multi-axis machine tool (for example, the five-axis machine tool 20A, 20B or 20C) that includes three linear axes and one or more rotary axes so as to produce an evaluation work piece (for example, the evaluation work piece 30) to execute at least one of processing in which the inclination of a tool is changed so as to form a free curved surface, processing in which in a boundary portion of two adjacent regions of a flat surface, machining is performed at different angles of the tool between the two regions and processing in which the amount of movement of the rotary axis of the tool is set larger than the amount of movement of a tool tip point so as to form a corner portion.

(6) Yet another aspect of the present disclosure is a data structure of CAD data in a control system (for example, the control system 10) which includes: a CAM device (for example, the CAM device 200) that generates a machining program based on the CAD data; and a numerical controller that drives, based on the machining program, a multi-axis machine tool (for example, the five-axis machine tool 20A, 20B or 20C) including three linear axes and one or more rotary axes so as to produce an evaluation work piece (for example, the evaluation work piece 30), and the data structure is provided for machining at least one of, in the evaluation work piece, a curved surface portion in which the inclination of a tool is changed and which is formed with a free curved surface, a boundary portion of two regions of a flat surface which is machined at different angles of the tool and which includes the two adjacent regions and a corner portion in which the amount of movement of the rotary axis of the tool is larger than the amount of movement of a tool tip point.

### EXPLANATION OF REFERENCE NUMERALS

10 control system
20A, 20B, 20C five-axis machine tool
30 evaluation work piece
31 curved surface portion
32 boundary portion 32
33 corner portion

What is claimed is:

1. An evaluation work piece which is machined with a multi-axis machine tool that includes three linear axes and one or more rotary axes, the evaluation work piece comprising:
at least one of a curved surface portion in which an inclination of a tool is changed, a boundary portion of two regions of a flat surface which is machined at different angles of the tool and which includes the two adjacent regions and a corner portion in which an amount of movement of the rotary axis is larger than an amount of movement of a tool tip point.

2. The evaluation work piece according to claim 1, wherein the curved surface portion is formed to be a free curved surface.

3. The evaluation work piece according to claim 1, comprising: a stage-shaped machined portion; and a twisted machined portion which is formed on the stage-shaped machined portion, wherein the boundary portion is formed in a front surface of the stage-shaped machined portion, and the curved surface portion and the corner portion are formed in the twisted machined portion.

4. The evaluation work piece according to claim 1, wherein the multi-axis machine tool is a machine tool of a table rotation type in which a table is linearly moved and is rotationally moved, a machine tool of a mixed type in which a table is linearly moved and in which a head is rotationally moved or a machine tool of a head rotation type in which a head is linearly moved and is rotationally moved.

5. A non-transitory computer readable recording medium recording a machining program for instructing a computer serving as a numerical controller which drives a multi-axis machine tool that includes three linear axes and one or more rotary axes so as to produce an evaluation work piece to execute at least one of processing in which an inclination of a tool is changed so as to form a free curved surface, processing in which in a boundary portion of two adjacent regions of a flat surface, machining is performed at different angles of the tool between the two regions and processing in which an amount of movement of the rotary axis of the tool is set larger than an amount of movement of a tool tip point so as to form a corner portion.

6. A non-transitory computer readable recording medium recording a data structure of CAD data in a control system which includes: a CAM device that generates a machining program based on the CAD data; and a numerical controller that drives, based on the machining program, a multi-axis machine tool including three linear axes and one or more rotary axes so as to produce an evaluation work piece,
wherein the data structure is provided for machining at least one of, in the evaluation work piece, a curved surface portion in which an inclination of a tool is changed and which is formed with a free curved surface, a boundary portion of two regions of a flat surface which is machined at different angles of the tool and which includes the two adjacent regions and a corner portion in which an amount of movement of the rotary axis of the tool is larger than an amount of movement of a tool tip point.
